(19) United States
(12) Patent Application Publication
(10) Pub. No.: US 2025/0098676 A1
(43) Pub. Date: Mar. 27, 2025

(54) HIGH TEMPERATURE-STABLE AGROCHEMICAL COMPOSITION

(71) Applicant: SYNGENTA CROP PROTECTION AG, Basel (CH)

(72) Inventors: Rufai IBRAHIM, Greensboro, NC (US); Ankit FAJALIA, Greensboro, NC (US)

(73) Assignee: SYNGENTA CROP PROTECTION AG, Basel (CH)

(21) Appl. No.: 18/722,908

(22) PCT Filed: Dec. 20, 2022
(86) PCT No.: PCT/EP2022/087062

§ 371 Date: Jun. 21, 2024

Related U.S. Application Data
(60) Provisional application No. 63/292,130, filed on Dec. 21, 2021.

(51) Int. Cl. A01N 43/40; A01N 25/04; A01N 25/30; A01P 5/00

(52) U.S. Cl. CPC A01N 43/40; A01N 25/04; A01N 25/30; A01P 5/00

(57) ABSTRACT

The present invention relates to an agrochemical composition comprising: a. at least one agrochemically active compound; b. at least one pigment, in a w/w (weight/weight) concentration of at least 2%, based on total weight of the composition; and c. at least one nonionic surfactant selected from each of: an acrylic grafted polymer; a poloxamer; and a butyl polyalkylene oxide block copolymer. Preferably the at least active compound is a nematicide, more preferably cyclobutrifluram.

The present invention relates to formulations of active compounds comprising nematicides, pigments, and nonionic surfactants.

### BACKGROUND

Agrochemical compositions comprising one or more active compounds (i.e. pesticides) are commonly provided to an end user, e.g. a farmer, in a so-called optimized pre-mix formulation. The pre-mix formulation is diluted and mixed by the end user with water, and optionally other compounds, immediately prior to their application to crops in order obtain a working and effective pesticidal composition. This pre-mix formulation comprises high concentrations of pesticides and other formulation compounds that a.o. maintain the stability of the pesticides and provide subsequent optimal dilution and mixture conditions for the end user.

The pre-mix formulations offer advantages due to their high concentration of pesticides. Advantages due to cost include decreased transport, storage and packing costs, while advantages due to application include smaller quantities of pesticides being handled by the end user.

Active compounds from the 4-membered ring carboxamides, described in WO2013143811 and WO2015003951A1, such as cyclobutrifluram, are highly effective nematicides while also offering excellent fungicidal properties. Such compounds are suitable for inclusion in pre-mix formulations.

A pre-mix formulation may also contain colorants such as pigments. Stability of the formulation at high temperatures (e.g. at least 40° C.) is often a problem when the pigment concentration is high. Severe thickening and sedimentation occurs at high temperatures, which is detrimental to the overall stability of the formulation and its pesticides.

The present application has the object of providing formulations for active compounds from the 4-membered ring carboxamides comprising a high concentration of pigments, which have advantageous properties such as high stability at high temperatures.

### BRIEF SUMMARY OF THE DISCLOSURE

In accordance with the present invention there is provided an agrochemical composition comprising:
a. at least one agrochemically active compound;
b. at least one pigment, in a w/w (weight/weight) concentration of at least 2%, based on total weight of the composition; and
c. at least one nonionic surfactant selected from each of: an acrylic grafted polymer; a poloxamer; and a butyl polyalkylene oxide block copolymer.

### DETAILED DESCRIPTION

Applicants have surprisingly found that agrochemical compositions according to this aspect of the invention exhibit a high stability at high temperatures. This increased stability extends the shelf-life of such compositions, whilst also effectively controlling plant pests, such as insects, fungi and nematodes. The agrochemical compositions according to this aspect of the present invention advantageously exhibit less thickening and sedimentation at high temperatures, while they also do not exhibit a disadvantageous increase or decrease in viscosity.

Accordingly, the present invention relates to an agrochemical composition comprising:
a. at least one agrochemically active compound;
b. at least one pigment, in a w/w (weight/weight) concentration of at least 2%, based on total weight of the composition; and
c. at least one nonionic surfactant selected from each of: an acrylic grafted polymer; a poloxamer; and a butyl polyalkylene oxide block copolymer.

Active compounds from the 4-membered ring carboxamides, described in WO2013143811 and WO2015003951A1, such as cyclobutrifluram, are highly effective nematicides while also offering excellent fungicidal properties.

Preferably, the at least one agrochemically active compound according to the invention is a nematicide, more preferably cyclobutrifluram.

Cyclobutrifluram is a nematicide with fungicidal properties that is used for the treatment of crops. Its IUPAC name is N-[2-(2,4-dichlorophenyl)cyclobutyl]-2-(trifluoromethyl)-pyridine-3-carboxamide. It is typically used as a mixture of isomers containing 80-100% of the (1S,2S)-enantiomer and 20-0% of the (1R,2R)-enantiomer. Its molecular structure is C₁₇H₁₃Cl₂F₃N₂O. Its mechanism of action is proposed to be inhibition of the mitochondrial electron transport chain complex II.

Preferably, the at least one pigment according to the invention is present at a w/w concentration of at least 3%, based on total weight of the composition, more preferably at a concentration of at least 4%, even more preferably at a concentration of at least 5%.

Preferably, the at least one pigment according to the invention is present at a w/w concentration of from 2% to 30%, based on total weight of the composition, more preferably at a concentration of from 3% to 28%, even more preferably at a concentration of from 4% to 24%, most preferably of from 5% to 20%.

Suitable colouring agents can be dyes or pigmented colourants. Suitable dyes include: anthraquinone, triphenylmethane, phthalocyanine and derivatives thereof, and diazonium salts. Colourants can contain pigments such as pigment red 112 (CAS No. 6535-46-2), pigment red 2 (CAS No. 6041-94-7), pigment red 48:2 (CAS No. 7023-61-2), pigment blue 15:3 (CAS No. 147-14-8), pigment green 36 (CAS No. 14302-13-7), pigment green 7 (CAS No. 1328-53-6), pigment yellow 74 (CAS No. 6358-31-2), pigment orange 5 (CAS No. 3468-63-1), pigment violet 23 (CAS No. 6358-30-1), pigment black 7 (CAS No. 97793-37-8), and pigment white 6 (CAS No. 98084-96-9). The colouring agent may be present in the seed coating composition of the invention in an amount of 0-50 wt. %, based on the total weight of the coating composition. Preferably, the at least one pigment according to the invention is an organic pigment, preferably a monoazo pigment, more preferably a pigment selected from the list consisting of Pigment Red 48, Pigment Red 52, Pigment Red 57, and their metal salts, more preferably Pigment Red 48:1, the monoazo calcium salt with the chemical formula C₁₈H₁₁CaClN₂O₆S, with CAS: 7023-61-2.

The organic pigments may be suitably selected from Agrocer Red 112 dispersion, Agrocer Red 482 powder and/or Sunsperse Red 48:2. Agrocer Red 112 dispersion is an aqueous monoazo pigment dispersion, which is commercially available from Clariant. It comprises approximately 40 wt. % of a red mono azo dye, 40 wt. % water, 10 wt. % glycerol and 8% other ingredients. Agrocer Red 482 is a red mono azo organic pigment in powder form. Sunsperse Red 48:2 is a red monoazo organic pigment commercially available from Sun Chemicals.

Preferably, the at least one agrochemically active compound according to the invention is present at a w/w concentration of from 1% to 80%, based on total weight of the composition, more preferably at a concentration of from 10% to 45%, even more preferably at a concentration of from 20% to 40%, most preferably of from 35% to 38%

Preferably, the composition according to the invention further comprises:
d. at least one other active fungicide compound, preferably wherein the at least one other fungicide is a dioxolane, benzodioxole and/or acylalanine, preferably difenoconazole, metalaxyl and/or fludioxonil.

Preferably, the acrylic grafted polymer according to the invention has a hydrophilic-lipophilic balance (HLB) value of more than 6, preferably of more than 8, more preferably of more than 10.

Preferably, the poloxamer according to the invention has a HLB value of less than 9, preferably of less than 6, more preferably of less than 3.

Preferably, the butyl polyalkylene oxide block copolymer according to the invention has a HLB value of more than 6, preferably of more than 8, more preferably of more than 10.

Preferably, the acrylic grafted polymer according to the invention is present at a w/w concentration of from 0.1% to 10%, based on total weight of the composition, more preferably of from 0.2% to 5%, even more preferably of from 1% to 3% and most preferably of from 1% to 2.5%.

Preferably, the poloxamer according to the invention is present at a w/w concentration of from 0.1% to 10%, based on total weight of the composition, more preferably of from 0.2% to 5%, even more preferably of from 1% to 3% and most preferably of from 1.5% to 2.5%.

Preferably, the butyl polyalkylene oxide block copolymer according to the invention is present at a w/w concentration of from 0.1% to 10%, based on total weight of the composition, more preferably of from 0.2% to 5%, even more preferably of from 1% to 3% and most preferably of from 1.5% to 3.5%.

Within the context of the disclosure of the present invention, the following terms are defined as follows:

“Agrochemically active” should be understood as meaning effective for controlling nematode, insect, acarid pests and/or fungal pathogens of agronomic plants.

“Fungus” should be understood as encompassing all species of fungi, as well as all fungus-like organisms, such as oomycetes.

Polyalkylene oxide block copolymers can be di- and tri-block copolymers, such as ABA or BAB block copolymer or BA block copolymers. Examples of polyalkylene oxide block copolymers are poloxamers and butyl polyalkylene oxide block copolymers.

Poloxamers are nonionic tri-block copolymers composed of a central hydrophobic chain of polyoxypropylene (poly(propylene oxide)) flanked by two hydrophilic chains of polyoxyethylene (poly(ethylene oxide)).

Pluronic® L121 (BASF; CAS: 9003-11-6) is a preferred poloxamer. It is a difunctional block copolymer surfactant terminating in primary hydroxyl groups. It comprises poly(ethylene glycol)-block-poly(propylene glycol)-block-poly(ethylene glycol) polymers [PEG-PPG-PEG polymers]. It has a HLB value of between 1 and 2.

Butyl polyalkylene oxide block copolymers are di-block copolymers composed of butyl polyoxyethylene (poly(ethylene oxide))/polyoxypropylene (poly(propylene oxide)) block copolymers.

Toximul® 8320 (Stepan Chemical Co.; CAS No.: 9038-95-3) is a preferred butyl polyalkylene oxide block copolymer having an average molecular weight in the range of 2400 to 3500. It has a HLB value of 12.

Altox 4913 (Croda; CAS No.: 119724-54-8) is a preferred acrylic grafted polymer. It is a solution (water and glycol) of a comb-graft co-polymer comprising 36.6% methylmethacrylate, 1.9% methacrylic acid, both grafted with methoxypoly(ethylene glycol) 750 methacrylate (61.5%). Altox 4913 has a HLB value of around 12.

The agrochemical compositions according to the present invention comprise at least one acrylic grafted polymer. Acrylic grafted polymers are part of the larger group of graft polymer surfactants that are segmented copolymers with a linear backbone of one composite and randomly distributed branches of another composite.

A graft polymer surfactant can be a graft co-polymer surfactant. Graft co-polymers are a branched copolymer where the components of the side chain are structurally different than those of the main chain. The term “graft co-polymers” in relation to surfactants is used herein to refer to those polymers the structure of which, similar to that of a comb, has a backbone polymer chain to which are appended polymer chains different from the backbone which can be the same or of different natures and lengths. Comb-graft polymers can have a backbone chain of a polymer such as (meth)acrylic polymer or copolymer to which are appended polyoxyalkylated lateral groups such as polyoxyethylene groups. A graft co-polymer is a material that has polymer chains of one chemical composition branching out from a polymer backbone with a different chemical composition. Graft co-polymer surfactants can have a polymer backbone and polyether groups appended to the polymer backbone. Graft co-polymers that can be used in accordance with this invention include, but are not limited to graft co-polymers having a backbone polymer of at least one of acrylic acid, methacrylic acid, acrylate, methacrylate or methyl methacrylate, which have chains of another polymer, by way of non-limiting example, a polyether such as polyethylene glycol, extending from the polymer backbone.

Graft co-polymer surfactants with a polymer backbone formed of polymers such as acrylic acid, methacrylic acid, acrylate, methacrylate or methyl methacrylate polymers are referred to as “acrylic graft co-polymers” or “acrylic grafted polymers”. In a particularly preferably embodiment of the present invention, the graft polymer surfactant used in the composition may be described as graft co-polymer surfactants with a polymer backbone formed of polymers such as acrylic acid, methacrylic acid, acrylate, methacrylate or methyl methacrylate polymers and copolymers and polyethylene glycol (PEG) branches extending from this backbone. In two-dimensional representations, the PEG branches are drawn perpendicular to the acrylate polymer backbone (usually linear) and resemble the teeth of a com. Graft co-polymers of this type are occasionally referred to as “comb-graft polymers”.

Suitable graft co-polymer surfactants include, but are not limited to, non-ionic polyacrylate graft copolymers, such as Dispersogen PSL 100 from Clariant, modified polyacrylic acids such as Sokolan CP N40 from BASF, acrylic copolymers or acrylic grafted polymers, such as Atlox 4913 and Zephyrm PD3315 from Croda and Tersperse 2500 from Huntsman, acrylic polymers such as Emulson AG TRN 14105, Emulson AG TP1 and Emulson AG RHS from Lambérti and/or other graft copolymers such as Ethacryl P (a 35-45% comb-graft copolymer solution from Lyondell Chemical Co.) and/or AGNIQUE CP-72L.

Tersperse 2500 is a comb-graft copolymer solution (approx. 35 wt. % polymer) commercially available from Huntsman Corporation. Ethacryl P is a 35-45 wt. % comb-graft copolymer solution commercially available from Lyondell Chemical Company. Tersperse 2500 has CAS number of 111740-364.

Altox 4913 is a solution (water and glycol) of a comb-graft co-polymer or acrylic grafted polymer comprising 36.6% methylmethacrylate, 1.9% methacrylic acid, both grafted with methoxypoly(ethylene glycol) 750 methacrylate (61.5%), and is commercially available from Croda. Altox 4913 has a HLB value or around 12. Altox 3913 has a CAS number of 119724-54-8.

Preferably, the graft co-polymer or acrylic grafted polymer surfactants have a HLB number in the range from about 10 to about 16, more preferably a HLB number in the range from about 10 to 13.

The acrylic graft copolymer or acrylic grafted polymer according to the invention is preferably present in the range of from 0.5 to 3.0 wt. %, with respect to the weight of the total composition. More preferably, the acrylic graft copolymer or acrylic grafted polymer is present in the range of from 1.0 to 2.5 wt. %, even more preferably of from 1.25 to 2.25 wt. % and most preferably of from 1.50 to 2.00 wt. %, with respect to the weight of the total composition.

Preferably, the agrochemical compositions according to the present invention additionally comprise organic (co) solvents. The organic (co) solvents may be suitably selected from aromatic solvents, such as benzene, toluene, xylene or alkylnaphthalenes, chlorinated aromatic solvents, such as fluorobenzene or chlorobenzene, chlorinated aliphatic hydrocarbons, such as dichloromethane, aliphatic hydrocarbons, such as cyclohexane or paraffins, for example mineral oil, alcohols, such as methanol, ethanol, 2-propanol, butanol or glycol, as well as ethers, esters, ketones, such as acetone and/or dimethyl sulfoxide.

Preferably, the agrochemical compositions according to the present invention comprise of from 2 to 14 wt. % of organic (co) solvent, more preferably of from 4.0 to 12.0 wt. %, even more preferably of from 6.0 to 10.0 wt. % and most preferably of from 7.0 to 9.0 wt. % of organic (co) solvent, with respect to the total weight of the agrochemical composition.

More preferably, the agrochemical compositions according to the present invention additionally comprise organic (co) solvents, wherein the organic (so) solvent is one or more oils. The oil(s) may be suitably selected from any organic oil or combination of organic oils. Even more preferably, the oil(s) is (are) selected from an un-epoxidized or epoxidized, hydrogenated, partially hydrogenated and/or fully hydrogenated vegetable oils (for example epoxidized coconut oil, canola oil or soya oil). Most preferably, the oil is selected from any combination of palm oil, canola oil, peanut oil, coconut oil, soya oil and/or castor oil.

Preferably, the agrochemical compositions according to the present invention comprise of from 2 to 14 wt. % of oil, more preferably of from 4.0 to 12.0 wt. %, even more preferably of from 6.0 to 10.0 wt. % and most preferably of from 7.0 to 9.0 wt. % of oil, with respect to the total weight of the agrochemical composition.

In a preferable embodiment, agrochemical compositions according to the present invention additionally comprise antifreeze agents. The antifreeze agents may be suitably selected from propylene glycol and/or glycerine.

Preferably, the agrochemical compositions according to the present invention comprise of from 0.1 to 14 wt. % antifreeze agents, more preferably of from 2.0 to 12.0 wt. %, even more preferably of from 4.0 to 10.0 wt. % and most preferably of from 6.0 to 8.0 wt. % antifreeze agents, with respect to the total weight of the agrochemical composition.

In a preferable embodiment, agrochemical compositions according to the present invention additionally comprise dispersant packages. The dispersant packages may optionally comprise methylcellulose, sodium alkyl naphthalene sulfonates, poly(ethylene glycol)-block-poly(propylene glycol)-block-poly(ethylene glycol).

Preferably, the agrochemical compositions according to the present invention comprise of from 1 to 7 wt. % of dispersant packages, more preferably of from 2.0 to 6.0 wt. %, even more preferably of from 3.0 to 5.0 wt. % and most preferably of from 3.5 to 4.5 wt. % dispersant packages, with respect to the total weight of the agrochemical composition.

In a preferable embodiment, agrochemical compositions according to the present invention additionally comprise wetting agents. Wetting agents are surface-active molecules used to reduce the surface tension of water. Suitably wetting agents may advantageously comprise at least one polymer from water-soluble and water-dispersible film-forming polymers, more preferably with an average molecular weight of at least 10,000 to about 100,000. Such wetting agents advantageously improve the adherence of the active ingredients to the treated plant propagation material. Commercially available wetting agents include the following: Agnique® LVA (BASF), Agnique® PG 8105 (C8-10 alkyl polyglycoside (D.P.=1.5) ca. 65% active content, BASF), Agnique® PG 8107 (C8-10 alkyl polyglycoside (D.P.=1.7) ca. 70% active content, BASF), Agnique® PG 9116 (C9-11 alkyl polyglycoside (D.P.=1.6), BASF), Agnique® SLES 220/227/370 (alkylether sulfate, BASF), Agnique® SLES 28 RI (alkyl ether sulfate C12-14, sodium salt, BASF), Disponol SUS IC 875 (sulfosuccinate, BASF), Emulan® LVA (alcohol polyglycol ether, BASF), Emulan® TXI (alcohol polyglycol ether, BASF), Lutensol® TO 8 (ethoxylated C13 oxo alcohol (POE 8), BASF), Lutensol XL 40/50/60/70/79/80/89/90 (alkyl poly-propylene and ethylene glycol ethers made from a C10-Guerbet Alcohol and ethylene oxide, BASF), Lutensol XP 30/40/50/60/69/70/79/80/89/99/100 (alkyl polyethylene glycol ether based on C10-Guerbet alcohol and ethylene oxide, BASF), Morwet® D-425 Powder/Liquid (sodium salt of naphthalene sulfonate condensate, Nouryon), Plurafac® LF (fatty alcohol alkoxylate, BASF), Tamol® DN (phenol sulfonic acid condensation product, Na salt, BASF), Tamol® FB P1/NN 8906 (naphthalene sulfonic acid condensation product, Na salt, BASF) and Tetramethyldecynediol.

Preferably, the agrochemical compositions according to the present invention comprise of from 0.05 to 1.00 wt. % wetting agents, more preferably of from 0.10 to 0.90 wt. %, even more preferably of from 0.25 to 0.75 wt. % and most preferably of from 0.40 to 0.60 wt. % wetting agents, with respect to the total weight of the agrochemical composition.

Preferably, the agrochemical compositions according to the present invention additionally comprise inorganic carriers. Suitable inorganic carriers may optionally be selected from ground inorganic materials such as alumina, attapulgite, clays, diatomaceous earth, kaolin's, montmorillonite, quartz, silica, silicates and/or talc.

Preferably, the agrochemical compositions according to the present invention comprises of from 0.05 to 1.00 wt. % of inorganic carriers, more preferably of from 0.10 to 0.75 wt. %, even more preferably of from 0.20 to 0.50 wt. % and most preferably of from 0.30 to 0.40 wt. % of inorganic clay.

Preferably, the agrochemical compositions according to the present invention additionally comprise rheology modifiers.

Preferably, the agrochemical compositions according to the present invention additionally comprise preservatives.

Preferably, the agrochemical compositions according to the present invention additionally comprise buffer agents. Suitable buffer agents include sodium hydroxide, calcium carbonate, hydrochloric acid, phosphoric acid and/or nitric acid.

Preferably, the agrochemical compositions according to the present invention have a pH in the range of from 5 to 9, more preferably of from 5.5 to 8.5, even more preferably of from 5.7 to 8.0, most preferably of from 6.0 to 7.0.

Preferably, the agrochemical compositions according to the present invention additionally comprise anti-foaming agents.

The composition may also further comprise a fertilizer, a micronutrient donor or other preparations which influence the growth of plants as well as comprising a combination containing the compound of the invention with one or more other biologically active agents, such as bactericides, fungicides, nematocides, plant activators, acaricides, and insecticides.

Preferably, the agrochemical compositions according to the present invention do not gel.

A further aspect of the present invention relates to a tank mix of field use composition comprising the agrochemical composition according to the invention, and a diluent, preferably a liquid, more preferably wherein the liquid comprises water.

Another aspect of the present invention relates to a method of controlling or reducing pests, optionally fungi and/or nematodes, in a plant, comprising applying to a plant or habitat thereof a composition according to the invention.

Yet another aspect of the present invention relates to a method of controlling or preventing pathogenic damage or pest damage in a plant propagation material, a plant, parts of a plant and/or plant organs that grow at a later point in time, which comprises applying simultaneously on the plant, part of the plant, plant organs, plant propagation material or a surrounding thereof the composition according to the invention.

Preferably, the plant propagation material according to the invention is a seed.

A further aspect of the present invention relates to a plant propagation material treated with the composition according to the invention.

Preferably, the plant propagation material according to the invention is a seed.

Another aspect of the present invention relates to the use of the composition according to the invention to control or reduce fungus and/or nematode infestation in a plant or crop.

Embodiments according to the invention are provided as set out below.

Embodiment 1 provides an agrochemical composition comprising:
a. at least one agrochemically active compound;
b. at least one pigment, in a w/w (weight/weight) concentration of at least 2%, based on total weight of the composition; and
c. at least one nonionic surfactant selected from each of: an acrylic grafted polymer; a poloxamer; and a butyl polyalkylene oxide block copolymer.

Embodiment 2 provides an agrochemical composition according to embodiment 1, wherein the at least one agrochemically active compound comprises or is a nematicide.

Embodiment 3 provides an agrochemical composition according to embodiment 1 or 2, wherein the nematicide comprises or is cyclobutrifluram.

Embodiment 4 provides an agrochemical composition according to any one of embodiments 1, 2, or 3, wherein the at least one pigment is present at a w/w concentration of from 2% to 30%, based on total weight of the composition, more preferably at a concentration of from 3% to 28%, even more preferably at a concentration of from 4% to 24%, most preferably of from 5% to 20%.

Embodiment 5 provides an agrochemical composition according to any one of embodiments 1, 2, 3 or 4, wherein the at least one agrochemically active compound is present at a w/w concentration of from 1% to 80%, based on total weight of the composition, more preferably at a concentration of from 10% to 45%, even more preferably at a concentration of from 20% to 40%, most preferably of from 35% to 38%.

Embodiment 6 provides an agrochemical composition according to any one of embodiments 1, 2, 3, 4, or 5, wherein the at least one pigment is an organic pigment, preferably a monoazo pigment, more preferably a pigment selected from the list consisting of Pigment Red 48, Pigment Red 52, Pigment Red 57, and their metal salts, most preferably Pigment Red 48:1, the monoazo calcium salt with the chemical formula C₁₈H₁₁CaClN₂O6ₛ, CAS: 7023-61-2.

Embodiment 7 provides an agrochemical composition according to any one of embodiments 1, 2, 3, 4, 5, or 6, wherein the composition further comprises:
d. at least one other active fungicide compound, preferably wherein the at least one other fungicide is a dioxolane, benzodioxole and/or acylalanine, preferably difenoconazole, metalaxyl and/or fludioxonil.

Embodiment 8 provides an agrochemical composition according to any one of embodiments 1, 2, 3, 4, 5, 6, 7, or 8, wherein the at least one agrochemically active compound is cyclobutrifluram.

Embodiment 9 provides an agrochemical composition according to any one of embodiments 1, 2, 3, 4, 5, 6, 7, or 8, wherein the acrylic grafted polymer has a hydrophilic-lipophilic balance (HLB) value of more than 6, preferably of more than 8, more preferably of more than 10, the poloxamer has a HLB value of less than 9, preferably of less than 6, more preferably of less than 3, and/or the butyl polyalkylene oxide block copolymer has a HLB value of more than 6, preferably of more than 8, more preferably of more than 10.

Embodiment 10 provides an agrochemical composition according to any one of embodiments 1, 2, 3, 4, 5, 6, 7, 8, or 9, wherein the acrylic grafted polymer is present at a w/w concentration of from 0.1% to 10%, based on total weight of the composition, more preferably of from 0.2% to 5%, even more preferably of from 1% to 3% and most preferably of from 1% to 2.5%.

Embodiment 11 provides an agrochemical composition according to any one of embodiments 1, 2, 3, 4, 5, 6, 7, 8, 9 or 10, wherein the poloxamer is present at a w/w concentration of from 0.1% to 10%, based on total weight of the composition, more preferably of from 0.2% to 5%, even more preferably of from 1% to 3% and most preferably of from 1.5% to 2.5%.

Embodiment 12 provides an agrochemical composition according to any one of embodiments 1, 2, 3, 4, 5, 6, 7, 8, 9, 10 or 11, wherein the butyl polyalkylene oxide block copolymer is present at a w/w concentration of from 0.1% to 10%, based on total weight of the composition, more preferably of from 0.2% to 5%, even more preferably of from 1% to 3% and most preferably of from 1.5% to 3.5%.

Embodiment 13 provides a tank mix of field use composition comprising the agrochemical composition according to any one of embodiments 1, 2, 3, 4, 5, 6, 7, 8, 9, 10, 11, or 12, and a diluent, preferably a liquid, more preferably wherein the liquid comprises water.

Embodiment 14 provides a method of controlling or reducing pests, optionally fungi and/or nematodes, in a plant, comprising applying to a plant or habitat thereof a composition according to any one of embodiments 1, 2, 3, 4, 5, 6, 7, 8, 9, 10, 11, or 12.

Embodiment 15 provides a method of controlling or preventing pathogenic damage or pest damage in a plant propagation material, a plant, parts of a plant and/or plant organs that grow at a later point in time, which comprises applying simultaneously on the plant, part of the plant, plant organs, plant propagation material or a surrounding thereof the composition according to any one of embodiments 1, 2, 3, 4, 5, 6, 7, 8, 9, 10, 11, or 12.

Embodiment 16 provides a plant propagation material treated with the composition according to any one of embodiments 1, 2, 3, 4, 5, 6, 7, 8, 9, 10, 11, or 12.

Embodiment 17 provides a method according to embodiment 15 or 16, wherein the plant propagation material is a seed.

Embodiment 18 provides a use of the composition according to any of embodiments 1, 2, 3, 4, 5, 6, 7, 8, 9, 10, 11, or 12 to control or reduce fungus and/or nematode infestation in a plant or crop.

In one preferred group of agrochemical compositions according to the invention the composition comprises:
a. from 1 to 50 weight percent cyclobutrifluram, based on total weight of the composition, preferably, in ascending preference, of from 2% to 48%, of from 5% to 45%, of from 10% to 40%, of from 15% to 35%, of from 20% to 30% and most preferably of from 22% to 28% weight percent cyclobutrifluram, based on total weight of the composition.
b. from 0 to 50 weight percent pigment, based on total weight of the composition;
c. from 0 to 25 weight percent acrylic grafted polymer, based on total weight of the composition;
d. from 0 to 10 weight percent poloxamer, based on total weight of the composition; and
e. from 0 to 10 weight percent butyl polyalkylene oxide block copolymer, based on total weight of the composition.

In one preferred group of agrochemical compositions according to the invention the composition comprises:
a. from 1 to 15 weight percent cyclobutrifluram, based on total weight of the composition;
b. from 0.1 to 15 weight percent pigment, based on total weight of the composition;
c. from 0.1 to 5 weight percent acrylic grafted polymer, based on total weight of the composition;
d. from 0.1 to 5 weight percent poloxamer, based on total weight of the composition; and
e. from 0.1 to 15 weight percent butyl polyalkylene oxide block copolymer, based on total weight of the composition.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

In each aspect and embodiment of the invention, “consisting essentially”, as well as inflections thereof, are to be understood as a preferred embodiment of “comprising” and its inflections, and “consisting of” and inflections thereof are to be understood as a preferred embodiment of “consisting essentially of” and its inflections.

The reader's attention is directed to all papers and documents which are filed concurrently with or previous to this specification in connection with this application and which are open to public inspection with this specification, and the contents of all such papers and documents are incorporated herein by reference.

### EXAMPLES

### Example 1—Preparation of Sample B and Comparative Samples C, D, E, F, and G

A composition according to the invention (sample B) was compared to comparative compositions (samples C, D, E, F, and G). The compositions comprise the components in weight percent as outlined in Table 1 below. The compositions were prepared by mixing the listed components.

TABLE 1
compositions of samples B, C, D, E, F, and G, components in wt. %

| Component | C | D | E | F | G | B |
|---|---|---|---|---|---|---|
| Cyclobutrifluram (primary agrochemical | 10.43 | 10.43 | 10.43 | 10.43 | 10.43 | 10.43 |
| active ingredient) | | | | | | |
| Fludioxonil (secondary agrochemical active | 4.35 | 4.35 | 4.35 | 4.35 | 4.35 | 4.35 |
| ingredient) | | | | | | |
| Difenoconazole (secondary agrochemical | 5.35 | 5.35 | 5.35 | 5.35 | 5.35 | 5.35 |
| active ingredient) | | | | | | |
| Metalaxyl-M (secondary agrochemical active | 4.31 | 4.31 | 4.31 | 4.31 | 4.31 | 4.31 |
| ingredient) | | | | | | |
| Lignosulfonate | 0.70 | 0.70 | 0.70 | 0.70 | 0.70 | 0.70 |
| Pigment dispersion (UNISPERSE RED: C2B- | 7 | — | — | — | — | — |
| AGRO RS) | | | | | | |
| Pigment dispersion (SUNSPERSE RED: 48:2 | — | 7 | 7 | 7 | 7 | 10 |
| code RPD-0048) | | | | | | |
| Non-ionic surfactant 2 (PLURIOL WSB 125) | — | — | 2 | — | — | — |
| Non-ionic surfactant 2 (TOXIMUL 8320) | 2 | 2 | — | 2 | 2 | 3 |
| Antifreeze agent | 7.2 | 7.2 | 7.2 | 7.2 | 7.2 | 7.2 |
| Non-ionic surfactant 3 (PLURONIC L121) | 2 | 2 | 2 | — | — | 2 |
| Non-ionic surfactant 3 (PLURONIC P104) | — | — | — | 2 | — | — |
| Non-ionic surfactant 3 (PLURONIC L92) | — | — | — | — | 2 | — |
| Non-ionic surfactant 1 (ATLOX 4914) | 1 | 1 | 1 | 1 | 1 | — |
| Non-ionic surfactant 1 (ATLOX 4913, acrylic | — | — | — | — | — | 2 |
| graft polymer) | | | | | | |
| SOYBEAN OIL | 8 | 8 | 8 | 8 | 8 | 8 |
| Dispersant package | 4.381 | 4.381 | 4.381 | 4.381 | 4.381 | 2.381 |
| Wetting agent | 0.52 | 0.52 | 0.52 | 0.52 | 0.52 | 0.52 |
| Anti-foaming agents | 0.50 | 0.50 | 0.50 | 0.50 | 0.50 | 0.34 |
| Bentonite clay | 0.31 | 0.31 | 0.31 | 0.31 | 0.31 | 0.31 |
| Rheology modifier | 0.012 | 0.012 | 0.012 | 0.012 | 0.012 | 0.012 |
| Preservatives | 0.122 | 0.122 | 0.122 | 0.122 | 0.122 | 0.122 |
| Buffer agents | 0.055 | 0.055 | 0.055 | 0.055 | 0.055 | 0.071 |
| Water | 41.76 | 41.76 | 41.76 | 41.76 | 41.76 | 38.904 |

Primary active ingredient of both samples is cyclobutrifluram, and the secondary active ingredients of both samples are fludioxonil, difenoconazole and metalaxyl-M. The secondary active ingredients are commercially available.

The lignosulfonates used to formulate the samples were commercially available lignosulfates.

The primary non-ionic surfactants were either Atlox™ 4913 (according to the invention) or Atlox™ 4914 (comparative). Atlox™ 4913 is a commonly used non-ionic surfactant, commercially available from Croda Crop Care. It is an acrylic graft copolymer solution with a HLB value of 12. Atlox™ 4914 is a commonly used non-ionic surfactant, commercially available from Croda Crop Care. It is a non-ionic random polymer with a HLB value of 6.

The secondary non-ionic surfactant used was TOXIMUL® 8320, a commonly used non-ionic surfactant commercially available from the Stepan company. TOXIMUL® 8320 is a butyl polyalkylene oxide block copolymer. It has HLB value of 12.

Antifreeze agents used were ordinary commercially available antifreeze agents.

A conventionally employed Dispersant and Wetting Agent was employed, as disclosed in

McCutcheon's, vol. 1, “Emulsifiers and Detergents,” MC Publishing Company, Glen Rock, N.J., U.S.A., 1996. Additional inert ingredients useful in the present invention can be found in McCutcheon's, vol. 2, “Functional Materials,” MC Publishing Company, Glen Rock, N.J., U.S.A., 1996.

The pigment dispersion used was Sunsperse Red 48:2 [code RPD-0048], which is a commonly used pigment. It was obtained commercially from Sun Chemical Corporation. It is a monoazo calcium salt with the chemical formula C18H11CaClN2O6S, CAS: 7023-61-2).

The rheology modifier used was Rhodopol 23, commercially available from Solvay.

The pH of the compositions were adjusted to between 6 and 7, by adding appropriate quantities of buffer agents sodium hydroxide and phosphoric acid.

Pluronic® L121 is a commonly used non-ionic surfactant, commercially available from BASF. Pluronic® L121 is a difunctional block copolymer surfactant terminating in primary hydroxyl groups (CAS: 9003-11-6). It comprises poly(ethylene glycol)-block-poly(propylene glycol)-block-poly(ethylene glycol) polymers [PEG-PPG-PEG polymers]. It has a HLB value of between 1 and 2.

### Example 2—Analysis of Sample B and Comparative Samples C, D, E, F, and G

The compositions were assessed on the parameters pH, viscosity and particle size at different time points after preparation, while subjected to different conditions. Each composition was analyzed after preparation (Initial), after 1 week at 38° C. under shaking conditions, after 2 weeks under static conditions at room temperature (RT), 38° C., or 50° C., and after 2 weeks subjected to Basel Freeze Thaw (BFT) temperature cycles from 50° C. to −10° C. daily for 2 weeks.

BFT temperature cycling is a measure for the stability of compositions, comprising accelerated stability testing conditions. The accelerated testing conditions of BFT are that a sample is initially heated to 50° C., and then thermally cycled from 50° C. to −10° C. and back to 50° C. over a period 24 hours. This daily thermal cycle was repeated for 14 days. At the end of 14 days under accelerated stability testing conditions, samples were cooled to 20° C.

At the end of the other testing conditions, samples were also cooled to 20° C.

The cooled samples were then analysed by dynamic light scattering using a Malvern 300 Particle Size Analyzer using Universal Seedcare Method 1.0 based on CIPAC MT 187. The rheological properties of the samples were also analysed using Brookfield LVDV-I Prime, using #2 spindle at 30 RPM, based on using at 30 revolutions per minute (rpm) according to ASTM D 2196. pH of the samples was also determined. The results are outlined in Table 2 below.

TABLE 2
results of incubation of samples B, C, D, E, F and G

| | | | | Viscos- | Particle Size (μm) | | |
|---|---|---|---|---|---|---|---|
| | | Condition/ | | ity | D[4, | D(v, | D(v, |
| | | Time | pH | (cps) | 3] | 0.5) | 0.95) |
| C | Initial | | 5.69 | 537 | 3.201 | 2.446 | 8.18 |
| | 1 week 38° C. shaker | | 5.87 | 332 | 4.225 | 3.091 | 11.52 |
| | 2 weeks | RT | 5.9 | 400 | 4.180 | 3.205 | 10.205 |
| | | 38° C. | 5.97 | 282* | 4.014 | 3.140 | 9.397 |
| | | 50° C. | 5.97 | 379 | 10.05* | 8.638* | 25.509* |
| | | BFT | n/a | n/a | n/a | n/a | n/a |
| D | Initial | | 5.68 | 575 | 3.167 | 2.543 | 7.28 |
| | 1 week 38° C. shaker | | 5.92 | 422 | 5.515 | 3.174 | 20.26 |
| | 2 weeks | RT | 5.73 | 445 | 3.364 | 2.582 | 8.552 |
| | | 38° C. | 5.87 | 412 | 3.440 | 2.741 | 8.219 |
| | | 50° C. | 5.87 | 440 | 6.235* | 4.557* | 17.352* |
| | | BFT | 6.01 | 693 | 23.135* | 19.162* | 63.450* |
| E | Initial | | 5.75 | 675 | 3.582 | 2.812 | 8.86 |
| | 1 week 38° C. shaker | | 5.91 | 445* | 11.042* | 3.735* | 61.793* |
| | 2 weeks | RT | 5.83 | 576 | 3.330 | 2.622 | 7.99 |
| | | 38° C. | 5.85 | 561 | 5.611 | 4.318 | 12.45 |
| | | 50° C. | 5.90 | 535 | 8.484* | 5.700* | 24.614* |
| | | BFT | 5.89* | 432* | 19.636* | 11.721* | 64.270* |
| F | Initial | | 5.60 | 786 | 3.105 | 2.127 | 8.91 |
| | 1 week 38° C. shaker | | 5.76 | 701 | 8.727* | 3.065* | 36.232* |
| | 2 weeks | RT | 5.74 | 774 | 3.225 | 2.297 | 8.920 |
| | | 38° C. | 5.71 | 752 | 5.262 | 3.190 | 11.874 |
| | | 50° C. | 5.72 | 566* | 7.008* | 3.834* | 23.991* |
| | | BFT | 5.75 | 528* | 13.087* | 6.605* | 56.426* |
| G | Initial | | 5.85 | 721 | 3.112 | 2.333 | 8.16 |
| | 1 week 38° C. shaker | | 5.93 | 431* | 6.461* | 3.125* | 27.064* |
| | 2 weeks | RT | 5.90 | 645 | 3.174 | 2.429 | 8.039 |
| | | 38° C. | 5.87 | 683 | 4.743 | 3.298 | 10.25 |
| | | 50° C. | 5.92 | 700 | 11.062* | 8.247* | 30.540* |
| | | BFT | 5.89 | 1068* | 27.331* | 23.251* | 69.994* |
| B | Initial | | 7.09 | 458 | 3.592 | 3.005 | 8.22 |
| | 1 week 38° C. shaker | | 6.79 | 439 | 3.679 | 3.072 | 8.35 |
| | 2 weeks | RT | 6.98 | 447 | 3.657 | 3.043 | 8.414 |
| | | 38° C. | 6.62 | 366 | 3.734 | 3.078 | 8.822 |
| | | 50° C. | 6.72 | 377 | 3.704 | 3.074 | 8.539 |
| | | BFT | 6.71 | 400 | 5.799* | 3.132 | 23.336* |

“n/a” indicates no data available. Results marked with an asterisk indicate suboptimal values.

Issues of viscosity fluctuation and particle size increase for all samples C, D, E, F and G. Severe thickening and sedimentation of the compositions C, D, E, F and G occurs at high temperatures, which is detrimental to the overall stability of the formulation and its pesticides.

Sample B comprising a composition according to the invention has improved properties after 2 weeks at 50° C. with regard to viscosity fluctuation and particle size and thickening and sedimentation when compared with the comparative samples C, D, E, F and G. To a lesser extent the same holds true for the BFT experimental condition.

A lower particle size value indicates a better composition. Preferably, D [4,3] is lower than 8 μm, more preferably lower than 7 μm, even more preferably lower than 6 μm. Preferably, D (v, 0.95) is lower than 25 μm, more preferably lower than 20 μm, even more preferably lower than 15 μm.

Preferably, the viscosity is from 400 to 700 cps. In addition, the difference between initial viscosity and viscosity after 1 to 2 weeks is preferably less than 100 cps, which indicates that the composition has a stable viscosity.

From the results in Table 2 it can be observed that, after 2 weeks at 50° C., sample B comprising a composition according to the invention has a much smaller mean diameter (3.7 μm) over volume D [3,4] compared to the comparative samples (10.1, 6.2, 8.5, 7.0, 11.1 μm). The median for a volume distribution D [v, 0.5] was also advantageously lower for sample B (3.1 μm) as comparted to the comparative samples (8.6, 4.6, 5.7, 3.8, 8.2 μm). 95% of the particles in sample B were smaller than 8.5 μm (D [v, 0.95]), compared to the much larger values for the comparative samples, where 95% of the particles were smaller than 25.5, 17.4, 24.6, 24.0, or 30.5 μm.

The results thus show that a combination of Toximul 8320, a high HLB Ethylene Oxide/Propylene Oxide (EO/PO) block copolymer, Pluronic L121, a low HLB EO/PO block copolymer, and Atlox 4913, an acrylic graft copolymer, drastically improves physical stability of the agrochemical compositions at elevated temperature.

1. An agrochemical composition comprising:
a. cyclobutrifluram;
b. a pigment, in a w/w (weight/weight) concentration of 0% to 50%, based on total weight of the composition;
c. an acrylic grafted polymer; and
d. at least one other active fungicide compound selected from the group consisting of dioxolane, benzodioxole, acylalanine, difenoconazole, metalaxyl and fludioxonil.

2. (canceled)

3. (canceled)

4. The composition according to claim 1, wherein the pigment is present at a w/w concentration of from 2% to 30%, based on total weight of the composition.

5. The composition according to claim 1, wherein cyclobutrifluram is present at a w/w concentration of from 1% to 80%, based on total weight of the composition.

6. The composition according to claim 1, wherein the pigment is an organic pigment.

7. The composition according to claim 6, wherein the organic pigment is a monoazo calcium salt with the chemical formula C₁₈H₁CaClN₂O₆S, CAS: 7023-61-2.

8. (canceled)

9. The composition according to claim 1, wherein the acrylic grafted polymer has a hydrophilic-lipophilic balance (HLB) value of more than 6.

10. (canceled)

11. The composition according to claim 1, wherein the poloxamer is present at a w/w concentration of from 0.1% to 10%, based on total weight of the composition.

12. (canceled)

13. A tank mix of field use composition comprising the agrochemical composition according to claim 1, and a diluent.

14. A method of controlling or reducing pests, optionally fungi and/or nematodes, in a plant, comprising applying to a plant or habitat thereof a composition according to claim 1.

15. A method of controlling or preventing pathogenic damage or pest damage in a plant propagation material, a plant, parts of a plant and/or plant organs that grow at a later point in time, which comprises applying simultaneously on the plant, part of the plant, plant organs, plant propagation material or a surrounding thereof the composition according to claim 1.

16. The method according to claim 15, wherein the plant propagation material is a seed.

17. A plant propagation material treated with the composition according to claim 1.

18. Use of the composition according to claim 1 to control or reduce fungus and/or nematode infestation in a plant or crop.

19. The composition according to claim 1, wherein the composition further comprises a butyl polyalkylene oxide block copolymer.

20. The composition according to claim 2, wherein the butyl polyalkylene oxide block copolymer is present at a w/w concentration of from 0.1% to 10%, based on total weight of the composition.

21. The composition according to claim 1, wherein the acrylic grafted polymer is present at a w/w concentration of from 0.1% to 10%, based on total weight of the composition.
